(19) United States
(12) Patent Application Publication
(10) Pub. No.: US 2026/0037321 A1
(43) Pub. Date: Feb. 5, 2026

(54) CONTAINER SCHEDULING METHOD, AND COMPUTER DEVICE

(71) Applicant: JINGDONG TECHNOLOGY INFORMATION TECHNOLOGY CO., LTD., Beijing (CN)

(72) Inventors: Hui TU, Beijing (CN); Jiangang FAN, Beijing (CN); Guang ZHOU, Beijing (CN); Yefei YANG, Beijing (CN)

(73) Assignee: JINGDONG TECHNOLOGY INFORMATION TECHNOLOGY CO., LTD., Beijing (CN)

(21) Appl. No.: 18/995,951

(22) PCT Filed: May 12, 2023
(86) PCT No.: PCT/CN2023/093927

§ 371 Date: Jan. 17, 2025

(30) Foreign Application Priority Data
Sep. 26, 2022 (CN) 202211174579.4

(51) Int. Cl. G06F 9/50

(52) U.S. Cl. CPC G06F 9/5038; G06F 2209/503; G06F 2209/505

(57) ABSTRACT

A container scheduling method, includes: from a queue to be scheduled, obtaining N pods to be scheduled; recording a first version number of each schedulable node in a cluster; traversing second attribute information of each node on the basis of first attribute information of each pod to be scheduled, so as to determine a candidate node corresponding to each pod to be scheduled, and a second version number corresponding to the candidate node; and for any pod among the pods to be scheduled, if a second version number of a candidate node corresponding to the pod matches with the recorded first version number, using the candidate node to schedule the pod.

### CROSS REFERENCE TO RELATED APPLICATIONS

This application is a U.S. national phase application of International Application No. PCT/CN2023/093927 filed on May 12, 2023, which is based on and claims priority to Chinese Patent Application No. 202211174579.4, filed on Sep. 26, 2022, the entire contents of which are incorporated herein by reference for all purposes.

### TECHNICAL FIELD

The present disclosure relates to the field of computer technology, in particular, to a container scheduling method, a container scheduling apparatus, and a computer device.

### BACKGROUND

With the rapid development of the computer technology, the cluster is becoming increasingly widely used. Usually, in scenarios such as offline and online hybrid deployment, offline tasks etc., there may be situations where a large number of pod containers are scheduled in a short period of time for computing business.

### SUMMARY

A first aspect of the present disclosure provides a container scheduling method. The method includes:
obtaining N pod containers to be scheduled from a queue to be scheduled, where N is an arbitrary integer greater than 1:
recording a first version number currently corresponding to each schedulable node in a cluster:
determining a candidate node corresponding to each pod to be scheduled and a second version number of the candidate node by traversing second attribute information of each schedulable node based on first attribute information of each pod to be scheduled; and
for any pod among the pods, using, in response to the second version number of a candidate node corresponding to the pod matching with the first version number recorded, the candidate node to schedule the pod.

A second aspect of the present disclosure provides a container scheduling apparatus, including:
an obtaining module configured to obtain N pod containers to be scheduled from a queue to be scheduled, where N is an arbitrary integer greater than 1:
a recording module configured to record a first version number currently corresponding to each schedulable node in a cluster:
a traversing module configured to determine a candidate node corresponding to each pod to be scheduled and a second version number of the candidate node by traversing second attribute information of each schedulable node based on first attribute information of each pod to be scheduled; and
a processing module configured to for any pod among the pods, use, in response to the second version number of a candidate node corresponding to the pod matching with the first version number recorded, the candidate node to schedule the pod.

A third aspect of the present disclosure provides a computer device including: a memory, a processor, and a computer program stored on the memory and executable by the processor. The processor is configured to execute the computer program to perform the container scheduling method as described in the first aspect of the present disclosure.

A fourth aspect of the present disclosure provides a non-transitory computer-readable storage medium having a computer program stored thereon, which when executed by a processor, causes the container scheduling method as described in the first aspect of the present disclosure to be performed.

A fifth aspect of the present disclosure provides a computer program product including a computer program, which when executed by a processor, causes the container scheduling method as described in the first aspect of the present disclosure to be performed.

The additional aspects and advantages of the present disclosure will be partially presented in the following description, some of which will become apparent from the following description, or learned through practice of the present disclosure.

### BRIEF DESCRIPTION OF THE DRAWINGS

The above and/or additional aspects and advantages of the present disclosure will become apparent and easily understood from the following description of embodiments with reference to the drawings, in which,

FIG. 1 is a schematic flowchart of a container scheduling method according to one or more embodiments of the present disclosure:

FIG. 2 is a schematic flowchart of a container scheduling method according to one or more embodiments of the present disclosure:

FIG. 3 is a schematic diagram of a process of scheduling a container according to one or more embodiments of the present disclosure:

FIG. 4 is a schematic diagram of a structure of a container scheduling apparatus according to one or more embodiments of the present disclosure:

FIG. 5 shows a block diagram of a computer device suitable for implementing one or more embodiments of the present disclosure.

### DETAILED DESCRIPTION

The descriptions of embodiments of the present disclosure will be provided in the following in detail, examples of which are shown in the drawings. Identical or similar reference numerals represent identical or similar elements or elements with identical or similar functions throughout the present disclosure. The embodiments described in the following with reference to the drawings are exemplary and intended to explain the present disclosure, and should not be construed as limitations to the present disclosure.

A container scheduling method, a container scheduling apparatus, a computer device, and a storage medium according to one or more embodiments of the present disclosure are described in the following with reference to the drawings.

Embodiments of the present disclosure will be described by taking an example where the container scheduling method is configured in the container scheduling apparatus, and the container scheduling apparatus can be applied to any computer device to enable the computer device to perform the function of scheduling the container.

In some embodiments, the computer device can be a personal computer (PC), a cloud device, a mobile device, etc. The mobile device can be a hardware device with various operating systems, touch screens, and/or display screens, such as a mobile phone, a tablet, a personal digital assistant, a wearable device, an on-board device, etc.

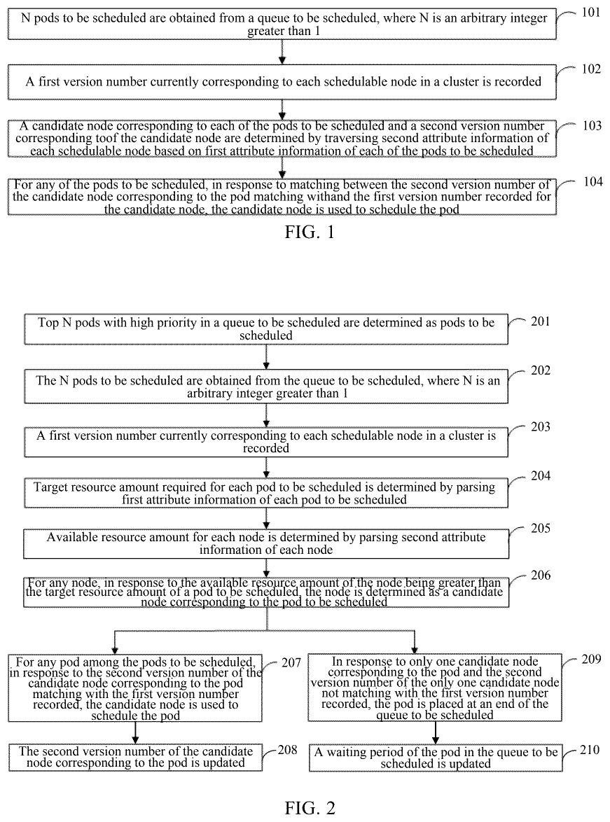

FIG. 1 shows a schematic flowchart of a container scheduling method according to one or more embodiments of the present disclosure.

As shown in FIG. 1, the container scheduling method can include the following steps.

In step 101, N pods to be scheduled are obtained from a queue to be scheduled, where N is an arbitrary integer greater than 1.

In some embodiments, the queue to be scheduled can include one or more pods. The queue to be scheduled can be a queue in the container cluster management system (Kubernetes, k8s), or a queue in any other cluster, etc. The present disclosure does not limit this.

In some embodiments, the pod can be the smallest scheduling unit in the cluster, which can include one or more containers, etc. The present disclosure does not limit this.

In some embodiments, N can be a pre-set value, such as 3, 5, 10, etc., or N can be adjusted as needed, etc. The present disclosure does not limit this.

In some embodiments, the scheduling can be understood as binding a pod to a node, and assigning to the pod, an internet protocol (IP) address, a central processing unit (CPU) resource, a memory resource, etc. The present disclosure does not limit this.

In some embodiments, the N pods to be scheduled obtained from the queue to be scheduled can be scheduled by different threads. For example, thread1 schedules pod1, thread2 schedules pod2, thread3 schedules pod3, and so on. In this way, according to the present disclosure, the multi-threaded concurrent pod scheduling can be achieved, thereby providing conditions for the speed improvement for scheduling the pod.

In step 102, a first version number currently corresponding to each schedulable node in a cluster is recorded.

In some embodiments, the schedulable node can be nodes within a cluster that can meet pod scheduling requests, etc. The present disclosure does not limit this.

In some embodiments, the version number can be a value of a specific field in the node, which can be used to represent the state information of the node. For example, by parsing the specific field in node1, the first version number of node1 can be determined to be “1”. Alternatively, by parsing the specific field in node2, the first version number of node2 can be determined to be “0”, and so on. The present disclosure does not limit this.

In this way, according to the present disclosure, the first version number corresponding to the schedulable node can be determined by parsing the specific field in the schedulable node, and recorded. The present disclosure does not limit this.

In step 103, a candidate node corresponding to each pod to be scheduled and a second version number of the candidate node are determined by traversing second attribute information of each schedulable node based on first attribute information of each pod to be scheduled.

In some embodiments, the first attribute information of the pod can be information such as target resource amount required by the pod, etc., and the second attribute information of the node can be resource amount, etc. that the node can provide currently. The present disclosure does not limit this.

In some embodiments, any pod to be scheduled can correspond to one or multiple candidate nodes. The present disclosure does not limit this.

In some embodiments, when the first attribute information of each pod to be scheduled and the second attribute information of each node are determined, each pod to be scheduled can be compared with each node based on the first attribute information and the second attribute information. For example, if the target resource amount of pod1 to be scheduled is X and the available resource amount of node1 is Y, and if Y is greater than X, then node1 can be determined as the candidate node corresponding to pod1 to be scheduled. Alternatively, if the target resource amount of pod2 to be scheduled is X, the available resource amount of node2 is Y, and the available resource amount of node3 is Z, and if both Y and Z are greater than X, then node2 and node3 can be determined as the candidate nodes corresponding to pod2 to be scheduled.

It should be noted that the above embodiments are only illustrative and cannot be used as limitations on the first attribute information of the pod to be scheduled, the second attribute information of the node, and the candidate nodes in the present disclosure.

It can be understood that after the candidate node corresponding to the pod to be scheduled is determined, the specific field in the candidate node can be parsed to determine the second version number corresponding to the candidate node, which will not be repeated here.

In step 104, for any of the pods to be scheduled, in response to the second version number of the candidate node corresponding to the pod matching with the first version number recorded for the candidate node, the candidate node is used to schedule the pod.

It can be understood that for any pod, if the second version number of the candidate node corresponding to the pod is the same as or consistent with the first version number recorded for the candidate node, it can be considered that the second version number of the candidate node matches with the first version number recorded for the candidate node.

In some embodiments, if the second version number of the candidate node corresponding to a pod is “1”, and the first version number recorded for the candidate node is also “1”, then it can indicate that the candidate node is currently in an available state and can be used to schedule the pod. The present disclosure does not limit this.

In some embodiments, further for a pod, after the pod has been scheduled using the candidate node, the second version number of the candidate node corresponding to the pod can be updated.

There are various ways to update the second version number of the candidate node. In some embodiments, the second version number can be updated by adding one, so as to obtain the updated version number. In some embodiments, the second version number can be updated according to specific rules, etc. The present disclosure does not limit this.

In some embodiments, for a pod, if the second version number of the candidate node corresponding to the pod is “0”, and the first version number recorded for the candidate node is also “0”, then the candidate node can be used to schedule the pod, and the second version number of the candidate node can be updated. For example, the second version number of the candidate node can be updated to “1”, and so on. The present disclosure does not limit this.

In this way, according to the present disclosure, the optimistic concurrency control can be used to achieve multi-threaded concurrency pod scheduling, thereby improving the speed of the pod cluster scheduling without affecting the quality of the cluster scheduling or changing the user usage manner.

According to embodiments of the present disclosure, N pod containers to be scheduled can be first obtained from the queue to be scheduled, and then the first version number currently corresponding to each schedulable node in the cluster can be recorded. The candidate node corresponding to each pod to be scheduled and the second version number corresponding to the candidate node are then determined by traversing second attribute information of each node based on the first attribute information of each pod to be scheduled. In the case where the second version number of the candidate node corresponding to a pod matches with the first version number recorded for the candidate node, the candidate node can be used to schedule the pod. In this way, after N pods to be scheduled and candidate nodes corresponding to the N pods are obtained, the version numbers of the candidate nodes can be verified. In the case where, for a pod, the after-obtained version number of the candidate node corresponding to the pod matches with the before-recorded version number, the candidate node can be used to schedule the pod. That is, the multi-threaded concurrency pod scheduling can be achieved by using the optimistic concurrency control, thereby improving the speed of the cluster scheduling without affecting the quality of the cluster scheduling.

FIG. 2 shows a schematic flowchart of a container scheduling method according to one or more embodiments of the present disclosure.

As shown in FIG. 2, the container scheduling method can include the following steps.

In step 201, top N pods with the highest priority in a queue to be scheduled are determined as pods to be scheduled.

In some embodiments, the priority of the pod can be determined based on a type of a task to be processed. In some embodiments, the priority of a computationally intensive task can be determined to be high, and the priority of an ordinary task can be determined to be low, and so on. The present disclosure does not limit this.

In some embodiments, N can be a pre-set value, such as 3, 5, 10, etc. The present disclosure does not limit this.

In some embodiments, in the case where the value of N is 3, if there are a total of 7 pods to be scheduled in the queue, among which pod1 and pod3 have high priorities, pod4 has a medium priority, and pod2, pod5, pod6, and pod7 have low priorities. Therefore, pod1, pod3, and pod4 can be determined as the pods to be scheduled, and so on. The present disclosure does not limit this.

In some embodiments, top N pods with the longest waiting period in the queue to be scheduled can also be determined as the pods to be scheduled.

In some embodiments, the waiting period can be a time period the pod has been waited for the scheduling after the pod enters the queue to be scheduled.

In some embodiments, pod1 enters the queue to be scheduled at 09:01, pod2 enters the queue to be scheduled at 09:03, pod3 enters the queue to be scheduled at 09:05, pod4 enters the queue to be scheduled at 09:07, and pod5 enters the queue to be scheduled at 09:08. In the case where the value of N is 4, if the current time is 09:10, then the waiting period for pod1 is 9 minutes, the waiting period for pod2 is 7 minutes, the waiting period for pod3 is 5 minutes, the waiting period for pod4 is 3 minutes, and the waiting period for pod5 is 2 minutes, and then, pod1, pod2, pod3, and pod4 can be determined as the pods to be scheduled, and so on. The present disclosure does not limit this.

In step 202, the N pods to be scheduled are obtained from the queue to be scheduled, where N is an arbitrary integer greater than 1.

In step 203, a first version number currently corresponding to each schedulable node in a cluster is recorded.

It should be noted that the specific contents and implementations of steps 202 and 203 can refer to the descriptions of other embodiments disclosed in the present disclosure, and will not be repeated here.

In step 204, target resource amount required for each pod to be scheduled is determined by parsing first attribute information of each pod to be scheduled.

In some embodiments, the first attribute information can characterize the attribute characteristics of the pod to be scheduled. In some embodiments, the first attribute information can be the resource amount, the number of CPU cores, the network bandwidth, the graphics card, the hard disk, etc. required for scheduling the pod. The present disclosure does not limit this.

It should be noted that the first attribute information of each pod to be scheduled can be parsed in any desirable way, so as to determine the target resource amount required for each pod to be scheduled. The present disclosure does not limit this.

In step 205, available resource amount for each schedulable node is determined by parsing second attribute information of each node.

In some embodiments, the second attribute information can characterize the attribute characteristics of the node. In some embodiments, the second attribute information can be the resource amount, the number of CPU cores, the network bandwidth, the graphics card, the hard disk, etc. that the node can provide. The present disclosure does not limit this.

It should be noted that the second attribute information of each node can be parsed in any desirable way, so as to determine the resource amount, the computing power, etc. that each node can provide. The present disclosure does not limit this.

In step 206, for any schedulable node, in response to the available resource amount of the node being greater than the target resource amount of a pod to be scheduled, the node is determined as a candidate node corresponding to the pod to be scheduled.

In some embodiments, if the target resource amount of pod1 to be scheduled is X, the available resource amount of node1 is Y, and Y is greater than X, then node1 can be determined as the candidate node corresponding to pod1 to be scheduled.

In some embodiments, if the number of CPU cores for pod1 to be scheduled is 12, the number of CPU cores for node1 is 13, and the number of CPU cores for node2 is 10, with 13 being greater than 12, then node1 can be determined as the candidate node corresponding to pod1 to be scheduled.

It should be noted that the above embodiments are only illustrative and cannot be used as limitations on the first attribute information of the pod to be scheduled, the second attribute information of the node, and the candidate nodes in the present disclosure.

In step 207, for any pod among the pods to be scheduled, in response to the second version number of the candidate node corresponding to the pod matching with the first version number recorded for the candidate node, the candidate node is used to schedule the pod.

In step 208, the second version number of the candidate node corresponding to the pod is updated.

It should be noted that the specific contents and implementations of steps 207 and 208 can refer to the descriptions of other embodiments disclosed in the present disclosure, and will not be repeated here.

In step 209, in response to only one candidate node corresponding to the pod and the second version number of the only one candidate node not matching with the first version number recorded for the candidate node, the pod is placed at an end of the queue to be scheduled.

In some embodiments, whether the second version number corresponding to the candidate node matches with the first version number recorded for the candidate node or not can be performed through verification based on a comparing and swapping strategy (CAS).

In some embodiments, the CAS operation is an optimistic concurrency strategy, which usually refers to an ability to maintain an optimistic attitude, believing that a concurrent execution process will not cause a competition problem in shared data, and whether the competition problem occurs or not in the shared data is only checked when modifying the shared data. If other threads have not modified the shared data during the modification, the modification is successful.

Therefore, if the second version number corresponding to any candidate node matches with the first version number recorded for the candidate node, it can be assumed that no other threads have modified the candidate node, and the corresponding pod can be bound to the candidate node. If the second version number corresponding to any candidate node does not match with the first version number recorded for the candidate node, it can be assumed that another thread has modified the candidate node, that is, the candidate node may have been occupied, it may not be able to provide the resources required by the pod, and the pod cannot be bound to the candidate node. Therefore, the pod can be placed back at the end of the queue to be scheduled to wait for scheduling.

In some embodiments, the candidate node corresponding to pod1 is node1, and the specific field in node1 can be parsed to determine the second version number of node1. For example, the second version number can be “1”. If the first version number recorded for node1 is “0”, which does not match with the second version number “1” corresponding to node1, then it indicates that node1 may have changed and may not be able to schedule pod1. Therefore, pod1 can be placed back at the end of the queue to be scheduled.

In some embodiments, the candidate nodes corresponding to pod1 and pod2 are both node1, and the first version number has been recorded for node1 is “0”. For example, for pod1, the current second version number of node1 is obtained first, namely “0”. The second version number of node1 corresponding to pod1 obtained currently matches with the first version number “0” recorded before. Then pod1 can be bound to node1, that is, node1 can be used to schedule pod1, and the second version number of node1 is updated, for example, updated to “1”. Next, for pod2, the current second version number of node1 can be obtained by parsing node1, such as “1”. The second version number of node1 obtained currently does not match with the first version number “0” recorded before, and thus pod2 can be placed at the end of the queue to be scheduled.

It should be noted that the above embodiments are only illustrative and cannot be used as limitations on the second version number and the first version number of the candidate node in the present disclosure.

In step 210, a waiting period of the pod in the queue to be scheduled is updated.

It can be understood that if the pod is placed back at the end of the queue to be scheduled, the waiting period of the pod in the queue to be scheduled can be updated.

In some embodiments, the waiting period of pod1 before re-entering the queue to be scheduled is T1. After pod1 is placed back at the end of the queue to be scheduled, the waiting period of pod1 can be re-determined based on T1. For example, for the first time, the waiting period of pod1 in the queue to be scheduled is T1, and pod1 is placed back at the end of the queue to be scheduled at t. If the current time is t1, then the waiting period of pod1 at the current time is T1+(t1−t0). The present disclosure does not limit this.

According to the present disclosure, after N pods to be scheduled are obtained, the candidate node corresponding to each pod to be scheduled can be determined, and then matching can be performed between the second version number and the first version number of each candidate node. If the second version number of the candidate node matches with the first version number of the candidate node, the candidate nodes is used to schedule the pod. If the second version number of the candidate node does match with the first version number of the candidate node, the pod corresponding to the candidate node is placed back into the queue to be scheduled. In this way, the multi-threaded concurrency pod scheduling can be achieved through the optimistic concurrency control, thereby improving the speed of the pod cluster scheduling without affecting the quality of the cluster scheduling or requiring users to change their manners.

It should be noted that the container scheduling method provided in the present disclosure can be applied to any scenario of scheduling containers.

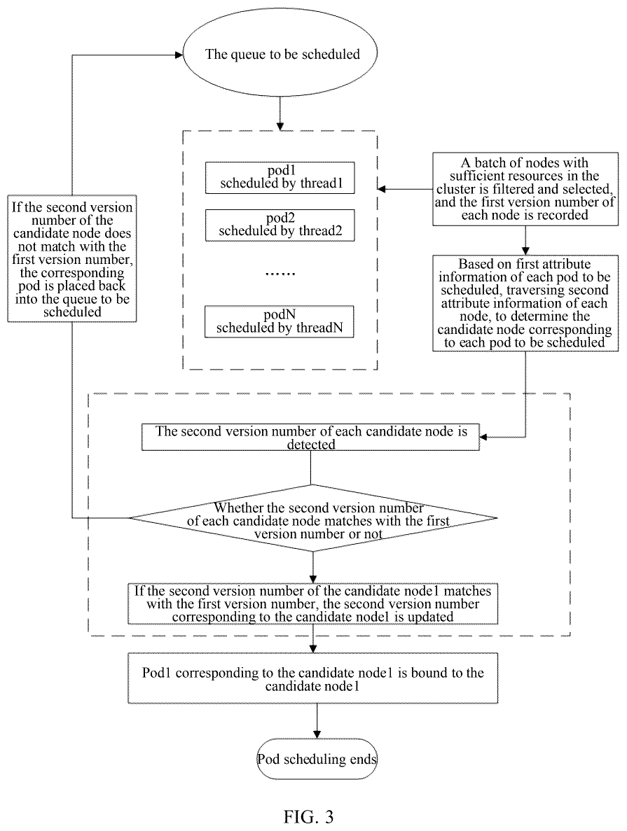

The process of scheduling the container provided in embodiments of the present disclosure will be explained in the following with reference to FIG. 3.

It can be understood that in the multi-threaded scenario, each thread can schedule a pod accordingly. As shown in FIG. 3, N pods to be scheduled can be obtained from the queue to be scheduled first, where pod1 is scheduled by thread1, pod2 is scheduled by thread2, . . . , podN is scheduled by threadN. Then a batch of nodes with sufficient resources in the cluster can be filtered and selected, and the first version number of each node can be recorded.

Next, in some embodiments, based on the first attribute information of each pod to be scheduled, the second attribute information of each node is traversed, so as to determine the candidate node corresponding to each pod to be scheduled. Next, in some embodiments, the second version number of each candidate node can be detected, and whether the second version number of each candidate node matches with the first version number or not can be determined. That is, whether the version number of the candidate node has changed is determined. For any candidate node, if the second version number of the candidate node matches with the first version number, that is, the version number of the candidate node has not changed, the second version number of the candidate node is updated and the corresponding pod is bound to the node. If the second version number of the candidate node does not match with the first version number, that is, the version number of the candidate node has changed, the corresponding pod is placed back into the queue to be scheduled.

For example, if the second version number of the candidate node1 does not match with the first version number, then pod1 corresponding to the candidate node1 should be placed back into the queue to be scheduled. If the second version number of the candidate node1 matches with the first version number, the second version number corresponding to the candidate node1 can be updated, and pod1 corresponding to the candidate node1 can be bound to the candidate node1, so that the candidate node1 can be used to schedule pod1, which ends the scheduling for pod1.

It can be understood that for the other pods to be scheduled, reference can be made to the above pod 1 scheduling process, and will not be repeated here.

It should be noted that the above embodiments are only illustrative and cannot be used as limitations on the process of scheduling containers in the present disclosure.

According to the present disclosure, the first M pods with the highest priority in the queue to be scheduled can be determined as the pods to be scheduled. Then, N pod containers to be scheduled can be obtained from the queue to be scheduled, and the first version number corresponding to each schedulable node in the cluster can be recorded. The first attribute information of each pod to be scheduled can be parsed to determine the target resource amount required for each pod to be scheduled. The second attribute information of each node can be parsed to determine the available resource amount of each node. For any node of the schedulable nodes in the cluster, if the available resource amount of the node is greater than the target resource amount of the pod to be scheduled, the node can be determined as the candidate node corresponding to the pod to be scheduled. For any pod of the N pods to be scheduled, if the second version number of the candidate node corresponding to the pod matches with the first version number recorded, the candidate node is used to schedule the pod, and the second version number of the candidate node corresponding to the pod is updated. In some embodiments, in the case where only one candidate node corresponds to the pod and the second version number of the candidate node does not match with the first version number recorded, the pod is placed at the end of the queue to be scheduled and the waiting period of the pod in the queue to be scheduled is updated. In this way, after N pods to be scheduled and candidate nodes corresponding to the N pods are obtained, the version number of the candidate node can be verified. In the case where the version numbers of the candidate node match with each other, the candidate node can be used to schedule the pod. When the version numbers of the candidate node change, the pod corresponding to the candidate node can be placed back into the queue to be scheduled. As a result, the multi-threaded concurrency pod scheduling can be achieved through the optimistic concurrency control, thereby improving the speed of the pod cluster scheduling without affecting the quality of the cluster scheduling or requiring users to change their manners.

In order to implement the above embodiments, the present disclosure further provides a container scheduling apparatus.

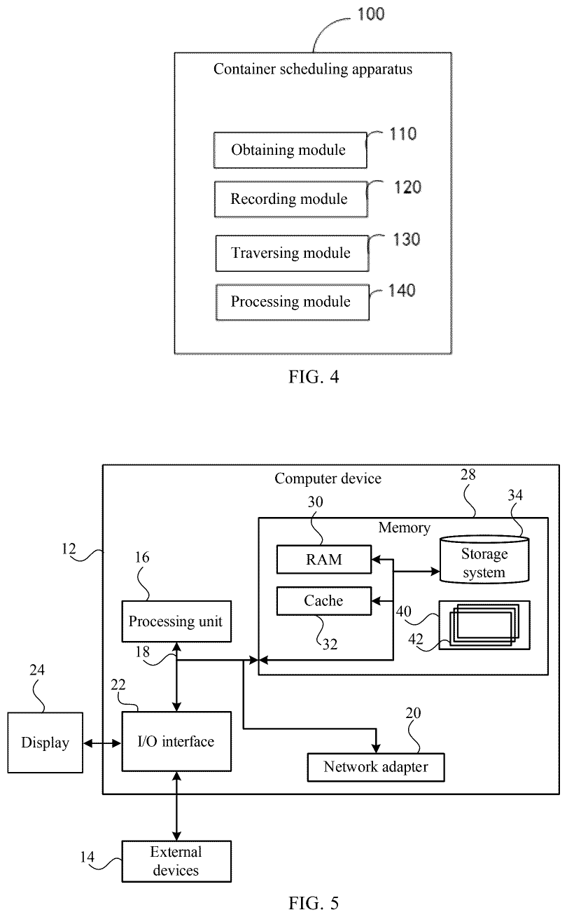

FIG. 4 shows a schematic diagram of a structure of a container scheduling apparatus according to one or more embodiments of the present disclosure.

As shown in FIG. 4, the container scheduling apparatus 100 can include an obtaining module 110, a recording module 120, a traversing module 130, and a processing module 140.

In some embodiments, the obtaining module 110 is configured to obtain N pod containers to be scheduled from a queue to be scheduled, where N is an arbitrary integer greater than 1.

In some embodiments, the recording module 120 is configured to record a first version number currently corresponding to each schedulable node in a cluster.

In some embodiments, the traversing module 130 is configured to determine a candidate node corresponding to each pod to be scheduled and a second version number of the candidate node by traversing second attribute information of each schedulable node based on first attribute information of each pod to be scheduled.

In some embodiments, the processing module 140 is configured to for any pod among the pods, use, in response to the second version number of a candidate node corresponding to the pod matching with the first version number recorded for the candidate node, the candidate node to schedule the pod.

In some embodiments, the processing module 140 is further configured to:
update the second version number of the candidate node corresponding to the pod.

In some embodiments, the processing module 140 is further configured to:
place, in response only one candidate node corresponding to the pod and the second version number of the candidate node not matching with the first version number recorded for the candidate node, the pod at an end of the queue to be scheduled:
update a waiting period of the pod in the queue to be scheduled.

In some embodiments, the traversing module 130 is specifically configured to:
determine target resource amount required for each pod to be scheduled by parsing the first attribute information of each pod to be scheduled:
determine available resource amount of each node by parsing the second attribute information of each node:
for any node, determine, in response to the available resource amount of the node being greater than the target resource amount required for a pod to be scheduled, the node as the candidate node corresponding to the pod to be scheduled.

In some embodiments, the obtaining module 110 is specifically configured to:
determine top N pods with the longest waiting periods in the queue to be scheduled as the pods to be scheduled: or determine top N pods with the highest priorities in the queue to be scheduled as the pods to be scheduled.

The functions and specific implementation principles of the above-mentioned modules in embodiments of the present disclosure can refer to the above-mentioned method embodiments, and will not be repeated here.

According to the container scheduling apparatus provided in embodiments of the present disclosure, N pod containers to be scheduled can be first obtained from the queue to be scheduled, and then the first version number currently corresponding to each schedulable node in the cluster can be recorded. The candidate node corresponding to each pod to be scheduled and the second version number corresponding to the candidate node are then determined by traversing second attribute information of each node based on the first attribute information of each pod to be scheduled. In the case where the second version number of the candidate node corresponding to a pod matches with the first version number recorded for the candidate node, the candidate node can be used to schedule the pod. In this way, after N pods to be scheduled and candidate nodes corresponding to the N pods are obtained, the version numbers of the candidate nodes can be verified. In the case where, for a pod, the after-obtained version number of the candidate node corresponding to the pod matches with the before-recorded version number, the candidate node can be used to schedule the pod. That is, the multi-threaded concurrency pod scheduling can be achieved by using the optimistic concurrency control, thereby improving the speed of the cluster scheduling without affecting the quality of the cluster scheduling.

In order to implement the above embodiments, the present disclosure also provides a computer device. The computer device includes a memory, a processor, and a computer program stored on the memory and executable by the processor. When the processor executes the computer program, the container scheduling method provided in the above embodiments of the present disclosure is implemented.

In order to implement the above embodiments, the present disclosure also provides a non-transitory computer-readable storage medium having a computer program stored thereon. When the computer program is executed by a processor, the container scheduling method provided in the above embodiments of the present disclosure is implemented.

In order to implement the above embodiments, the present disclosure also provides a computer program product. When the instructions in the computer program product is executed by a processor, the container scheduling method provided in the above embodiments of the present disclosure is implemented.

FIG. 5 shows a block diagram of a computer device suitable for implementing one or more embodiments of the present disclosure. The computer device 12 shown in FIG. 5 is only an example and should not impose any limitations on the functionality and the use scope of embodiments of the present disclosure.

As shown in FIG. 5, a computer device 12 is represented in the form of a general-purpose computing device. The components of the computer device 12 can include, but are not limited to, one or more processors or processing units 16, a system memory 28, and a bus 18 that connects different system components (including the system memory 28 and the processing units 16).

The bus 18 represents one or more of several types of bus structures, including a memory bus or a memory controller, a peripheral bus, a graphics acceleration port, a processor, or a local bus using any bus structure of the bus structures. In some embodiments, these architectures include but are not limited to the Industry Standard Architecture (ISA) bus, the Micro Channel Architecture (MAC) bus, the enhanced ISA bus, the Video Electronics Standards Association (VESA) local bus, and the Peripheral Component Interconnection (PCI) bus.

The computer device 12 typically includes various computer-readable media. These media can be any available media that can be accessed by the computer device 12, including volatile and non-volatile media, removable and non-removable media.

The memory 28 can include a computer system readable medium in the form of the volatile memory, such as Random Access Memory (RAM) 30 and/or cache memory 32. The computer device 12 can further include other removable/non-removable, volatile/non-volatile computer system storage media. For example only, the storage system 34 can be used to read and write the non-removable, non-volatile magnetic media (not shown in FIG. 5, commonly referred to as “hard disk drive”). Although not shown in FIG. 5, a disk drive can be provided for reading and writing the removable non-volatile disks (such as “floppy disks”), as well as for removable non-volatile optical disks (such as Compact Disc Read Only Memory, referred to as CD-ROM), disc drives for reading and writing the digital multi-functional read-only memory (Digital Video Disc Read Only Memory, referred to as DVD ROM), or other optical media. In these cases, each drive can be connected to the bus 18 through one or more data medium interfaces. The memory 28 can include at least one program product having a set (e.g., at least one) of program modules configured to perform the functions provided in embodiments of the present disclosure.

A program/utility 40 having a set (at least one) of program modules 42 can be stored, for example, in the memory 28. Such program modules 42 include but are not limited to an operating system, one or more application programs, other program modules, and program data, each of which or some combination thereof may include an implementation of the network environment. The program module 42 typically performs the functions and/or methods described in embodiments of the present disclosure.

The computer device 12 can also communicate with one or more external devices 14 (such as a keyboard, a pointing device, a display 24, etc.), and can also communicate with one or more devices that enable users to interact with the computer device 12, and/or with any device that enables the computer device 12 to communicate with one or more other computing devices (such as a network card, a modem, etc.). The communication can be carried out through an input/output (I/O) interface 22. Moreover, the computer device 12 can also communicate with one or more networks (such as a local area network (LAN), a wide area network (WAN), and/or a public network, such as the Internet) through a network adapter 20. As shown in the figure, the network adapter 20 communicates with other modules of the computer device 12 through the bus 18. It should be understood that although not shown in the figure, other hardware and/or software modules can be used in conjunction with the computer device 12, including but not limited to microcodes, device drivers, redundant processing units, external disk drive arrays, RAID systems, tape drives, and data backup storage systems, etc.

The processing unit 16 executes various functional applications and data processing by running programs stored in the system memory 28, such as implementing the methods mentioned in previous embodiments.

According to technical solutions of the present disclosure, N pod containers to be scheduled can be first obtained from the queue to be scheduled, and the first version number currently corresponding to each schedulable node in the cluster is then recorded. Based on the first attribute information of each pod to be scheduled, the second attribute information of each node is traversed, so as to determine the candidate node corresponding to each pod to be scheduled and the second version number corresponding to the candidate node. For any pod among the pods to be scheduled, if the second version number of the candidate node corresponding to the pod matches with the first version number recorded, the candidate node can be used to schedule the pod. Therefore, after N pods to be scheduled and their corresponding candidate nodes are obtained, the version numbers of the candidate node can be verified. In the case where, for a pod, the after-obtained version number of the candidate node corresponding to the pod matches with the before-recorded version number, the candidate node can be used to schedule the pod. That is, the multi-threaded concurrency pod scheduling can be achieved by using the optimistic concurrency control, thereby improving the speed of the cluster scheduling without affecting the quality of the cluster scheduling.

In the description of the specification, the reference to the terms “one embodiment”, “some embodiments”, “examples”, “specific examples”, or “some examples”, mean that the specific features, structures, materials, or characteristics described in conjunction with the embodiment or example are included in at least one embodiment or example in the present disclosure. In the specification, the schematic expressions of the above terms do not necessarily refer to the same embodiments or examples. Moreover, the specific features, structures, materials, or characteristics described can be combined in any one or more embodiments or examples in an appropriate manner. In addition, those skilled in the art can incorporate and combine the different embodiments or examples described in this specification, as well as the features of different embodiments or examples, without conflicting with each other.

In addition, the terms “first” and “second” are only used for descriptive purposes and cannot be understood as indicating or implying relative importance or implying the number of technical features indicated. Therefore, the features that are limited to “first” and “second” can explicitly or implicitly include at least one feature. In the present disclosure, the term “multiple” means at least two, such as two, three, etc., unless otherwise specified.

Any process or method description in a flowchart or otherwise described herein can be understood as representing a module, a fragment, or a portion of codes including executable instructions for implementing one or more steps of a customized logic function or process, and the scope of the preferred embodiments disclosed herein includes additional implementations, which may not be in the order shown or discussed, but may be performed in a substantially simultaneous manner or in reverse order based on the functions involved, which should be understood by those skilled in the art to which the embodiments disclosed herein belong.

The logic and/or steps represented in a flowchart or otherwise described herein, such as a sequential list of executable instructions used to implement logical functions, can be specifically implemented in any computer-readable medium for use by instruction execution systems, devices, or equipment (such as computer-based systems, systems including processors, or other systems that can take instructions from instruction execution systems, devices, or equipment and execute the instructions), or used in conjunction with these instruction execution systems, devices, or equipment. In the specification, “computer-readable medium” can be any device that can contain, store, communicate, disseminate, or transmit programs for use in instruction execution systems, devices, or equipment, or in combination with such instruction execution systems, devices, or equipment. More specific examples of computer-readable media (non-exhaustive list) include electrical connectors (electronic devices) with one or more wiring, portable computer enclosures (magnetic devices), Random Access Memory (RAM), Read-Only Memory (ROM), Erasable Programmable Read-Only Memory (EPROM or flash memory), fiber optic devices, and Compact Disc Read-Only Memory (CDROM). In addition, computer-readable media can even be paper or other suitable media on which the program can be printed, as the program can be obtained electronically, for example, by optical scanning of paper or other media, followed by editing, interpretation, or necessary processing in other suitable ways, and then stored in the computer memory.

It should be understood that the various parts disclosed in the present disclosure can be implemented using hardware, software, firmware, or a combination thereof. In the above embodiments, multiple steps or methods can be implemented using software or firmware stored in the memory and executed by a suitable instruction execution system. For example, if implemented in hardware as in another implementation, any one or a combination of the following techniques known in the art can be used: discrete logic circuits with logic gate circuits for implementing logic functions on data signals, application specific integrated circuits with suitable combinational logic gate circuits, programmable gate arrays (PGA), field programmable gate arrays (FPGA), etc.

Those of ordinary skill in the art can understand that all or part of the steps included in methods of implementing the above embodiments can be completed by instructing relevant hardware through a program. The program can be stored in a computer-readable storage medium, and when the program is executed, one or a combination of the steps of the methods provided in the embodiments can be included.

In addition, the various functional units in the embodiments of the present disclosure can be integrated into one processing module, or they can exist separately physically, or two or more units can be integrated into one module. The above-mentioned integrated modules can be implemented in the form of hardware or software functional modules. If the integrated modules are implemented in the form of software functional modules and sold or used as independent products, they can also be stored in a computer-readable storage medium.

The above-mentioned storage medium can be Read-Only Memory, magnetic disk, optical disk, etc. Although the embodiments of the present disclosure have been shown and described in the above, it can be understood that the above embodiments are exemplary and should not be construed as limiting the present disclosure. Those of ordinary skill in the art can make changes, modifications, substitutions, and variations to the above embodiments within the scope of the present disclosure.

1. A container scheduling method, comprising:
obtaining N pods to be scheduled from a queue to be scheduled, where N is an arbitrary integer greater than 1;
recording a first version number of each schedulable node in a cluster;
determining a candidate node corresponding to each pod to be scheduled and a second version number of the candidate node after the first version number is recorded, by traversing second attribute information of each schedulable node based on first attribute information of each pod to be scheduled; and
for any pod among the pods to be scheduled, determining, in response to the second version number of a candidate node corresponding to the pod matching with the first version number recorded for the candidate node, to use the candidate node to schedule the pod.

2. The method according to claim 1, further comprising:
updating the second version number of the candidate node corresponding to the pod after determining to use the candidate node to schedule the pod.

3. The method according to claim 1, further comprising:
placing, in response only one candidate node corresponding to the pod and the second version number of the candidate node not matching with the first version number recorded, the pod at an end of the queue to be scheduled; and
updating a waiting period of the pod in the queue to be scheduled.

4. The method according to claim 1, wherein determining the candidate node corresponding to each pod to be scheduled and the second version number of the candidate node by traversing the second attribute information of each schedulable node based on the first attribute information of each pod to be scheduled, comprises:
determining target resource amount required for each pod to be scheduled by parsing the first attribute information of each pod to be scheduled;
determining available resource amount of each schedulable node by parsing the second attribute information of each schedulable node; and
for any schedulable node in the cluster, determining, in response to the available resource amount of the node being greater than the target resource amount required for a pod to be scheduled, the node as the candidate node corresponding to the pod to be scheduled.

5. The method according to claim 1, wherein obtaining the N pods to be scheduled from the queue to be scheduled, comprises:
determining top N pods with the longest waiting periods in the queue to be scheduled as the pods to be scheduled; or
determining top N pods with the highest priorities in the queue to be scheduled as the pods to be scheduled.

6-10. (canceled)

11. A computer device comprising a memory, a processor, and a computer program stored on the memory and executable by the processor, wherein the processor is configured to:
obtain N pods to be scheduled from a queue to be scheduled, where N is an arbitrary integer greater than 1;
record a first version number of each schedulable node in a cluster;
determine a candidate node corresponding to each pod to be scheduled and a second version number of the candidate node after the first version number is recorded, by traversing second attribute information of each schedulable node based on first attribute information of each pod to be scheduled; and
for any pod among the pods to be scheduled, determine, in response to the second version number of a candidate node corresponding to the pod matching with the first version number recorded for the candidate node, to use the candidate node to schedule the pod.

12. A non-transitory computer-readable storage medium having a computer program stored thereon, which when executed by a processor, causes a container scheduling method to be performed, wherein the container scheduling method comprises:
obtaining N pods to be scheduled from a queue to be scheduled, where N is an arbitrary integer greater than 1;
recording a first version number of each schedulable node in a cluster;
determining a candidate node corresponding to each pod to be scheduled and a second version number of the candidate node after the first version number is recorded, by traversing second attribute information of each schedulable node based on first attribute information of each pod to be scheduled; and
for any pod among the pods to be scheduled, determining, in response to the second version number of a candidate node corresponding to the pod matching with the first version number recorded for the candidate node, to use the candidate node to schedule the pod.

13. (canceled)

14. The computer device according to claim 11, wherein the processor is further configured to:
update the second version number of the candidate node corresponding to the pod after determining to use the candidate node to schedule the pod.

15. The computer device according to claim 11, wherein the processor is further configured to:
place, in response only one candidate node corresponding to the pod and the second version number of the candidate node not matching with the first version number recorded, the pod at an end of the queue to be scheduled; and
update a waiting period of the pod in the queue to be scheduled.

16. The computer device according to claim 11, wherein the processor is further configured to:
determine target resource amount required for each pod to be scheduled by parsing the first attribute information of each pod to be scheduled;
determine available resource amount of each schedulable node by parsing the second attribute information of each schedulable node; and
for any schedulable node in the cluster, determine, in response to the available resource amount of the node being greater than the target resource amount required for a pod to be scheduled, the node as the candidate node corresponding to the pod to be scheduled.

17. The computer device according to claim 11, wherein the processor is further configured to:
determine top N pods with the longest waiting periods in the queue to be scheduled as the pods to be scheduled; or
determine top N pods with the highest priorities in the queue to be scheduled as the pods to be scheduled.

18. The computer device according to claim 11, wherein whether the second version number of the candidate node corresponding to the pod matches with the first version number recorded or not is performed through verification based on a comparing and swapping strategy (CAS).

19. The method according to claim 1, wherein whether the second version number of the candidate node corresponding to the pod matches with the first version number recorded or not is performed through verification based on a comparing and swapping strategy (CAS).

20. The non-transitory computer-readable storage medium according to claim 12, wherein the container scheduling method further comprises:
updating the second version number of the candidate node corresponding to the pod after determining to use the candidate node to schedule the pod.

21. The non-transitory computer-readable storage medium according to claim 12, wherein the container scheduling method further comprises:
placing, in response only one candidate node corresponding to the pod and the second version number of the candidate node not matching with the first version number recorded, the pod at an end of the queue to be scheduled; and
updating a waiting period of the pod in the queue to be scheduled

22. The non-transitory computer-readable storage medium according to claim 12, wherein the container scheduling method further comprises:
determining target resource amount required for each pod to be scheduled by parsing the first attribute information of each pod to be scheduled;
determining available resource amount of each schedulable node by parsing the second attribute information of each schedulable node; and
for any schedulable node in the cluster, determining, in response to the available resource amount of the node being greater than the target resource amount required for a pod to be scheduled, the node as the candidate node corresponding to the pod to be scheduled.

23. The non-transitory computer-readable storage medium according to claim 12, wherein the container scheduling method further comprises:
determining top N pods with the longest waiting periods in the queue to be scheduled as the pods to be scheduled; or
determining top N pods with the highest priorities in the queue to be scheduled as the pods to be scheduled

24. The non-transitory computer-readable storage medium according to claim 12, wherein whether the second version number of the candidate node corresponding to the pod matches with the first version number recorded or not is performed through verification based on a comparing and swapping strategy (CAS).
